(19) United States
(12) Patent Application Publication
(10) Pub. No.: US 2024/0329208 A1
(43) Pub. Date: Oct. 3, 2024

(54) Optoelectronic sensor for detecting an object in a monitored zone

(71) Applicant: SICK AG, Waldkirch (DE)

(72) Inventors: Oliver OSTOJIC, Waldkirch (DE); Mathias HUG, Waldkirch (DE)

(21) Appl. No.: 18/618,250

(22) Filed: Mar. 27, 2024

(30) Foreign Application Priority Data
Mar. 28, 2023 (DE) 102023107903.4

(51) Int. Cl. G01S 7/481; G01S 17/10

(52) U.S. Cl. CPC G01S 7/4816; G01S 7/4817; G01S 17/10

(57) ABSTRACT

An optoelectronic sensor for detecting an object in a monitored zone is provided that comprises a light transmitter for transmitting transmitted light, a light receiver having a plurality of light reception elements operable in Geiger mode for receiving transmitted light remitted in the monitored zone, a reception optics arranged upstream of the light receiver and having a diaphragm, and a control and evaluation unit that is configured to determine a distance from the object with reference to a received signal of the light receiver from a time of flight between the transmission of the transmitted light and the reception of the remitted received light, wherein the diaphragm comprises a diaphragm substrate having at least one metallic layer and one diaphragm aperture. In this respect, a contact region of the metallic layer for potential equalization is electrically conductively connected to another component of the sensor.

The invention relates to an optoelectronic sensor for detecting an object in a monitored zone.

A number of optoelectronic sensors work in accordance with the scanning principle in which a light beam is transmitted into the monitored zone and the light beam reflected by objects is received again in order then to electronically evaluate the received signal. In distance-measuring systems, a distance from the object is also measured in addition to the pure object detection. Distance sensors in accordance with the time of flight principle (LiDAR) for this purpose measure the time of flight of a light signal that corresponds to the distance via the speed of light. A distinction is conventionally made between pulse-based measurement and phase-based measurement. In a pulsed time of flight process, a brief light pulse is transmitted and the time up to the reception of a remission or reflection of the light pulse is measured. Alternatively, in a phase process, transmitted light is amplitude modulated and a phase shift between the transmitted light and the received light is determined, with the phase shift likewise being a measure for the time of flight.

To expand the measured zone of a single-beam light scanner, the scanning beam can be moved, on the one hand, as is the case in a laser scanner. A light beam generated by a laser there periodically sweeps over the monitored zone with the help of a deflection unit. In addition to the measured distance information, a conclusion is drawn on the angular location of the object from the angular position of the deflection unit and the site of an object in the monitored zone is thus detected in two-dimensional polar coordinates.

Another possibility for extending the measured zone and for acquiring additional distance data comprises simultaneously detecting a plurality of measured points using a plurality of scanning beams. This can also be combined with a laser scanner that then does not only detect a monitored plane, but also a three-dimensional spatial zone via a plurality of monitored planes. The scanning movement is achieved by a rotating mirror in most laser scanners. Particularly on the use of a plurality of scanning beams, however, it is also known in the prior art to instead have the total measurement head with the light transmitters and light receivers rotate, as is described, for example, in DE 197 57 849 B4.

The selection of the reception element and the optical design of such a sensor have a substantial influence on its performance. To be able to detect even small reception intensities, avalanche photodiodes (APDs) are used in some cases.

The incident light here triggers a controlled avalanche effect. The charge carriers generated by incident photons are thereby multiplied and a photocurrent is produced that is proportional to the received light intensity, but that is in this respect substantially larger than with a simple PIN diode.

An even greater sensitivity is achieved with avalanche photodiodes that are operated in the so-called Geiger mode (SPADs, single-photon avalanche diodes. also SiPMs, silicon photomultipliers). In this respect, the avalanche photodiode is biased above the breakdown voltage such that a single charge carrier released by a single photon can already trigger an avalanche that is no longer controlled and that then recruits all the available charge carriers due to the high field strength. The avalanche photodiode thus, like the eponymous Geiger counter, counts individual events. Avalanche photodiodes in Geiger mode are not only highly sensitive, but also comparatively inexpensive. They can additionally be integrated on a circuit board with little effort.

The high sensitivity, however, also brings about disadvantages since it is not only restricted to the transmission wavelength used in the sensor, but also acts in a wide wavelength range that also includes extraneous light. In this respect, due to the comparatively large detector surface of SPADs, their external light input is also high. The amount of extraneous light in turn here decisively determines the signal to noise ratio (SNR). Extraneous light can be filtered by use of an optical bandpass filter that is tuned to the wavelength of the transmitted light and that in particular provides a considerable improvement of the signal-to-noise ratio with broadband extraneous light such as sunlight. This alone, however, often does not yet produce satisfactory results.

It is furthermore possible to limit the extraneous light in that a focusing of the received light beam is provided in the reception path and in that a diaphragm is position at the position where the cross-section is the smallest. Such a diaphragm, however, has to be adjusted and fixed in place. Due to component tolerances and to a limited adjustment quality, the diaphragm aperture is in practice selected as larger than would in particular be ideal for a signal to noise ratio that is advantageous as possible. Signal losses due to received light portions that cannot pass through a diaphragm that is too small or that is displaced with respect to the received light beam would bring along a disproportionate loss of quality. Extraneous light passing through the diaphragm aperture beside the received light beam results in random detection events whose influence contributes as shot noise in accordance with a root function.

If the losses due to a non-ideal diaphragm are to be limited, low-tolerance components will have to be developed and produced and then adjusted with high precision and fixed in position with low distortion. This increases the manufacture due to component costs and complex and laborious processes that are additionally insufficiently flexible. It is additionally necessary to deal with dangerous materials such as adhesives, soldering apparatus and the like in the production process. There is moreover the difficulty in multibeam systems of aligning a plurality of transmission/reception pairs with one another and to nevertheless configure the diaphragms with high precision.

A conventional diaphragm insert is therefore only of limited use due to the large mechanical tolerances and thus diaphragm aperture. An alternative diaphragm on the chip level of the reception element reduces the illuminated region so that the useful light is also restricted with the extraneous light with a large-area SPAD receiver.

EP 3 432 023 B1 discloses a method of manufacturing an optoelectronic sensor having a diaphragm that is manufactured individually for every sensor using its own reception optics. The diaphragm itself is, however, not specified in more detail here. DE 10 2020 109 596 A1 deals with an optoelectronic sensor having a diaphragm and a manufacturing process for same. The diaphragm is configured as at least one diaphragm aperture in an absorption layer of a multilayer substrate.

Due to the extreme sensitivity of SPADs, at least the light receiver is conventionally protected from electromagnetic interference (EMC, electromagnetic compatibility) by metallic shielding. However, this has nothing to do with the optical diaphragm function. On the contrary, the diaphragm and the shield are spatially in one another's way.

In DE 20 2013 005 999 U1, an optical smoke detector operating in accordance with the scattered light principle is protected from EMC radiation by means of a shield device. A circuit board having a copper layer as a shield layer is inserted into the shield device and a photosensor is mounted on its inner side and thus surrounded by the shield device and the shield layer. A passage opening for light to be detected is provided in the circuit board in the form of a circular bore through the circuit board. The passage opening is simultaneously an optical diaphragm that only allows light incident from a scattering center of the smoke detector to pass in a direction toward the photosensor.

It is therefore the object of the invention to further improve the time of flight measurement while using a reception optics having a diaphragm.

This object is satisfied by an optoelectronic sensor for detecting an object in a monitored zone 1. The sensor comprises a light transmitter for transmitting transmitted light and a light receiver that again receives the transmitted light remitted i the monitored zone. The light transmitter can form a coaxial or biaxial arrangement with the light receiver. The sensor has a light receiver having a plurality of light reception elements operable in a Geiger mode. Such a SPAD receiver or SiPM receiver is, as explained in the introduction, particularly sensitive and additionally has a fast response time. A plurality of light reception provide an even larger detection surface and additionally enables a statistical evaluation. A control and evaluation unit is configured to evaluate a received signal of the light receiver to determine a distance of the objects from a time of flight between the transmission of the transmitted light and the reception of the splitting of the received light having the remitted transmitted light. The sensor thus implements the LiDAR measuring principle described in the introduction on the basis of SPADs or SiPMs.

A reception optics having a diaphragm is arranged upstream of the light receiver, for example a single lens, an object having a plurality of lenses, or another arrangement of optical elements. The diaphragm is preferably arranged in a focal plane of the reception optics so that a received light beam generated by the reception optics is incident on the point of smallest constriction through the diaphragm aperture of the diaphragm. Depending on the embodiment, the focal plane is not precisely impinged due to tolerances; this is always still called an arrangement in the focal plane. At least the extraneous light portion which reaches the reception optics on the near field or at intermediate distances can be suppressed by the diaphragm. The diaphragm aperture is preferably located within the focal plane where the received light beam passes through the diaphragm so that where possible no useful signal portions are lost in the diaphragm. The diaphragm comprises a diaphragm substrate having at least one metallic layer and a diaphragm aperture. In principle, the diaphragm substrate can be metal and thus be identical to the metallic layer. A diaphragm substrate such as glass, plastic, or a thin metallic carrier film that is then coated is preferably provided due to the better machining possibilities. In this respect, further layers for other functions are possible, as will be explained below, in addition to said at least one metallic layer.

The invention starts from the basic idea of using the diaphragm as part of an EMC shield. A contact region of the metallic layer for potential equalization is metallically conductively connected to another component of the sensor for this purpose. The other component can be one of the already named components, in particular the control and evaluation unit. The other component is preferably grounded so that the metallic layer of the diaphragm is then also grounded. Two contact regions are preferably provided at both sides of the diaphragm aperture and are respectively electrically conductively connected to the other component.

The invention has the advantage that the diaphragm that, in accordance with the invention, has an EMC shield is not only compatible, but also contributes thereto in a dual function. The optical function of the diaphragm is thus ensured of where possible only allowing the remitted transmitted light to reach the light receiver largely without any superposed extraneous light. At the same time, very good EMC protection is achieved that the very small diaphragm aperture only minimally impairs. The sensor can therefore overall measure with particularly good sensitivity, robustness, and accuracy.

The sensor preferably has a conductive shield at least of the light receiver. The conductive shield provides EMC protection at the points and in the directions where the diaphragm is not present. In other words, the conductive shield and the diaphragm conductively connected to the other component together complement one another to form EMC protection, preferably in all directions.

The contact region is preferably electrically conductively connected to the shield. The shield is thus the other component to which the metallic layer for potential equalization is electrically conductively connected. The shield is in turn preferably grounded.

The contact region is preferably electrically conductively connected to an expansion card of the sensor, in particular to an expansion card of the control and evaluation unit. The expansion card or circuit board provides a suitable potential for the potential equalization, preferably a zero potential or a ground. The expansion card is thus the other component to which the metallic layer is electrically conductively connected. A complementary shield can likewise be conductively connected to the expansion card or the conductive connection takes place indirectly from the expansion card over the shield to the metallic layer or vice versa. The expansion card can be that of the control and evaluation unit, but also a different expansion card of the light receiver, light transmitter, a supply or interface of the sensor, and any other desired expansion card.

A voltage can preferably be applied to the metallic layer via the contact region to heat the metallic layer. The diaphragm is thus given yet a further function as a heating element or as particularly effective condensation protection. A voltage source is for this purpose preferably applied to two contact regions of the metallic layer. The voltage source can provide a settable or constant voltage or it is adapted, for example by the control and evaluation unit, dependent on the situation and depending on the application, operating phase, measured outside temperature, or moisture, and the like. The power loss and thus the heat can furthermore be influenced by the electrical and thermal resistance and thus in particular by the selection of layer thickness and material composition.

The at least one metallic layer is preferably arranged on a side of the diaphragm substrate facing the light receiver and/or remote from the light receiver. The metallic layer can therefore be provided at one side on one of the two sides of the diaphragm substrate or at both sides.

A metallic layer facing the light receiver is preferably at least partially exposed to reflect remitted light scattered back by the light receiver onto the light receiver again. The metallic layer here acts as a concentrator or as a residual light amplifier. Scattered light from the light receiver can thus still be registered; an efficiency increase of the measurement system thereby results. It must be noted that this scattered light is such that has already passed through the diaphragm, that is it is useful light and not extraneous light.

The exposed portion of the metallic layer is preferably structured to set reflection properties. The surface in the reflection region for backscattering remitted transmitted light onto the light receiver thus has a structure or a pattern that, for example, sets a preferred direction of the reflection to particularly effectively reflect the light onto the light receiver.

The diaphragm is preferably multilayer with at least one of the following additional layers on a side facing the light receiver and/or remote from the light receiver: an absorption layer, an anti-reflection layer, a filter layer. The metallic layer or the metallic layers are provided at any desired point therebefore or therebetween depending on the embodiment. Where necessary, the contact regions are left free or also grown additively on a further coating or they are subsequently exposed again, for example by means of laser ablation. A multilayer diaphragm having different additional functions is produced. It is conceivable to structure the metallic layer in particular by means of laser machining so that it becomes diffusively reflective or non-reflective.

An absorption layer provides that incident light that does not pass through the diaphragm aperture after the remission in the monitored zone does not yet reach the light receiver where possible even by multiple reflection. The absorption layer preferably has a metallic portion, in particular black titanium or black chromium, spray lacquer, and/or carbon nanotubes. Structure carbon nanotubes are known as VANTA, for example. They have a particularly strong absorption. Structured inorganic layers such as Acktar Metal Velvet are conceivable as a kind of intermediate form between a vapor deposited absorption layer and carbon nanotubes. An anti-reflection layer is in particular of advantage in combination with glass or plastic as the diaphragm substrate. Scattered light is thus above all suppressed at the exposed points of the diaphragm aperture. A filter layer, in particular having the characteristics of a bandpass filter, can additionally filter extraneous light outside the spectrum of the useful light of its own light transmitter. For the diaphragm admittedly provides that lateral extraneous light is suppressed. However, extraneous light that is not influenced by the diaphragm is necessarily also superposed in the core region of the received light beam that passes through the diaphragm aperture. A selection in dependence on the wavelength here further improves the signal-to-noise ratio.

The diaphragm aperture is preferably made with a laser, in particular with a laser ablation process. Even more preferably, ultrashort laser pulses are used for this purpose, that is pulses in the picosecond or femtosecond range. The diaphragm aperture is particularly preferably manufactured individually using the reception optics. The diaphragm or its diaphragm aperture is accordingly manufactured as an individual diaphragm using the reception optics specifically for just the reception optics with which it is used together in the optoelectronic sensor. The reception optics can be involved in the manner in that it is directly involved in the manufacture or in that its properties determine the manufacture of the diaphragm aperture. The diaphragm thus ideally matches the reception optics and the received light beam generated by the reception optics. The individual manufacture of the diaphragm replaces the adjustment or at least supplements it. Conventionally, in contrast, a diaphragm would be obtained as a component for at least an entire lot of sensors and the sensor either has to accept the consequence of tolerances or this aspect is compensated by a complex adjustment.

The diaphragm aperture is preferably manufactured by a laser whose optical path is guided through the reception optics, in particular in a laser ablation process. No advance measurement is preferably carried out at all on how the individual diaphragm should look for this purpose. Since the laser itself passes through the reception optics, its optical path corresponds to that of the remitted transmitted light. For this purpose, the laser should preferably have comparable geometrical beam properties, that is light from infinity, for example, should preferably be collimated. An artificial defocusing or an additional optical element is conceivable for the laser to compensate deviations of the optical path, for instance due to deviating wavelengths, between the material machining laser and the later useful light.

The diaphragm aperture is alternatively manufactured by a laser whose optical path is not guided through the reception optics, but is rather focused on the diaphragm layer, in particular in a laser ablation process. For this purpose, the position and shape of the individual diaphragm at the reception side is measured in advance. Equally, correction values of the diaphragm position should preferably be included. This method is in particular advantageous with a plurality of measurement layers. The remitted transmitted light beam is preferably measured in the installation position of the reception optics to acquire a property of the individual diaphragm aperture to be manufactured. Relevant properties can, for example, be the beam cross-section at specific distances or its location in space. In this respect, the direction of the optical axis of the reception unit is called the Z direction, without any restriction of generality.

The individual diaphragm aperture is preferably manufactured in a production line of the sensor. The manufacture of an individual diaphragm thus becomes an integral step within the conventional production. No parts have to be purchased and no special process effort is required for the procuring and supply of the individual diaphragms.

The sensor is preferably configured as a laser scanner and has a moving deflection unit with whose aid the transmitted light is conducted periodically through the monitored zone. The laser scanner scans a plane by the transmitted light in the course of the movement of the movable deflection unit. With a multi-beam measurement system, that will be presented directly, each transmitted light beam scans a separate layer, a multilayer scanner is produced. Only its central layer at an elevation of zero, if present at all, is a plane in the mathematical sense; the other layers are curved similar to a nested hourglass. The deflection unit is preferably configured in the form of a rotatable scanning unit that practically forms a movable measurement head in which light transmitters and/or light receivers and preferably also at least some of the control and evaluation unit are accommodated. The deflection unit can alternatively be a rotating mirror. With a multilayer scanner, however, this produces further curvature in the layers and also their mixing up because the elevation angle of the scan then depends on the rotational position.

The light transmitter is preferably configured to transmit a plurality of mutually separate light beams starting and the light receiver is preferably configured to generate respective received signals from a plurality of remitted light beams. The sensor thus becomes a multi-beam sensor or multiple sensor that scans a plurality of measurement points. The control and evaluation unit preferably measures a distance with each of the plurality of beams using the time of flight. The plurality of measurement beams preferably share the same reception optics. The diaphragm preferably has one diaphragm aperture per light beam.

The invention will be explained in more detail in the following also with respect to further features and advantages by way of example with reference to embodiments and to the enclosed drawing. The Figures of the drawing show in:

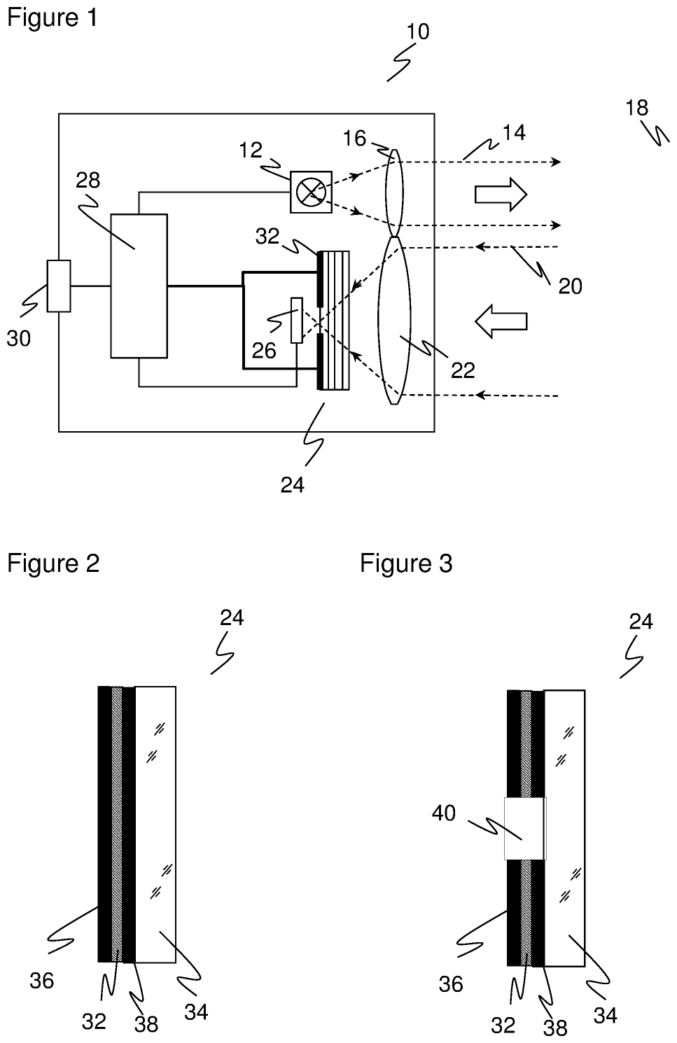

FIG. 1 a schematic sectional representation of an optoelectronic sensor;

FIG. 2 a schematic sectional representation of a layer system having a metallic layer from which a diaphragm is manufactured;

FIG. 3 a sectional view in accordance with FIG. 2, now with a diaphragm aperture;

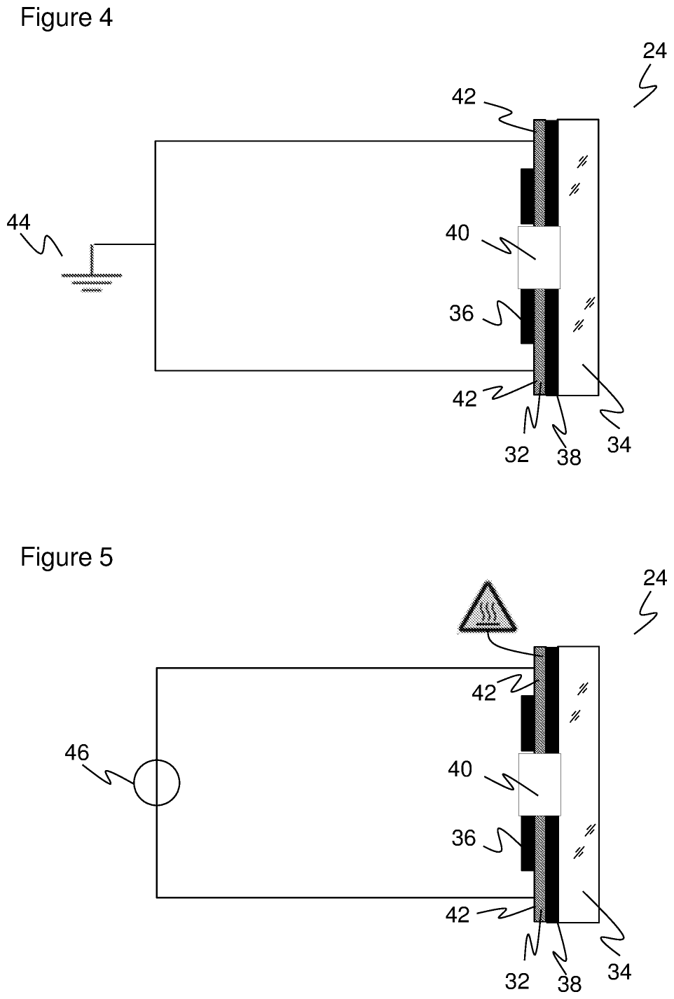

FIG. 4 a sectional view of a diaphragm in which a metallic layer for a potential equalization is connected to a grounded component;

FIG. 5 a sectional view of a diaphragm in which a metallic layer for heating is connected to a voltage source;

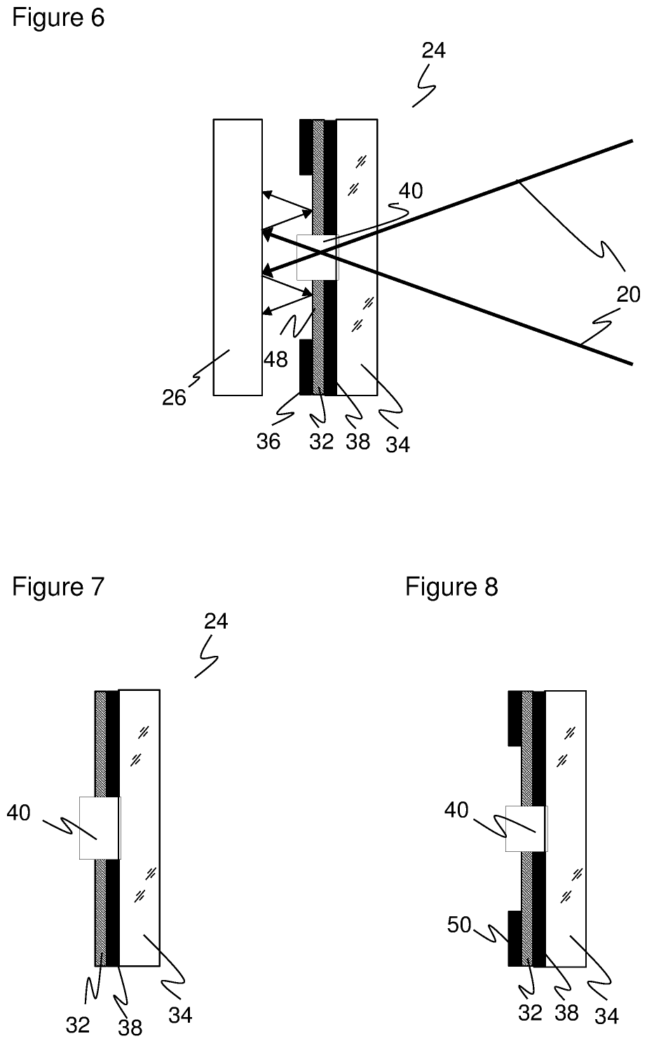

FIG. 6 a sectional view with a schematic beam path at a light receiver, with backscattered light portions from an exposed region of a metallic layer of a diaphragm being reflected toward the light receiver again;

FIG. 7 a sectional view of a multilayer diaphragm with a metallic layer;

FIG. 8 a sectional view in accordance with FIG. 7, now with a machining of the surface of the metallic layer at least in a partial region; and

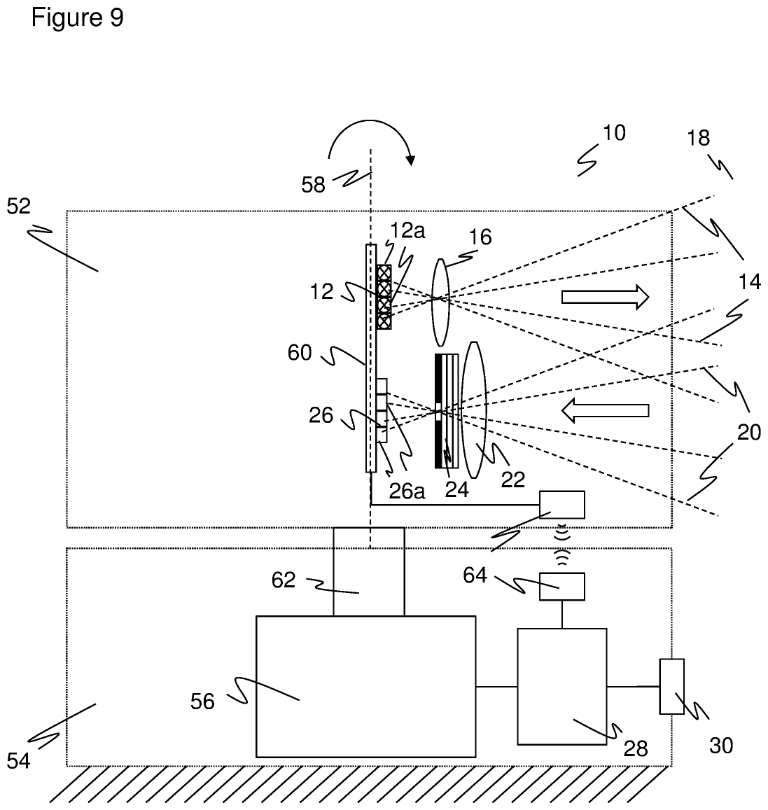

FIG. 9 a schematic sectional representation of an optoelectronic measuring sensor in an embodiment as a laser scanner.

FIG. 1 shows a block diagram of an optoelectronic sensor 10 that is configured by way of example as a light scanner here. The sensor 10 has a light transmitter 12, for example a laser diode, whose transmitted light 14 is collimated in a transmission optics 16 and is then transmitted into a monitored zone 18. The light remitted at objects in the monitored zone 18 is conducted as received light 22 by a reception optics 22 through a diaphragm 24 onto a light receiver 26. The light receiver 26 has a plurality of light reception elements or pixels in the form of avalanche photodiodes that are operated in Geiger mode for the highly sensitive detection of received light 20.

A control and evaluation unit 28 that is connected to the light transmitter 12 and to the light receiver 26 is furthermore provided. The control and evaluation unit 28 detects objects in the monitored zone 18 with reference to the received signal of the light receiver 26. In this respect, in an embodiment of the sensor 10 as a distance measuring light scanner, the distance of the detected objects is also measured by transmitting light pulse and determining the time of flight up to their reception. The control and evaluation unit 28 can output processed or raw measured sensor data via an interface 30 or can conversely accept control and parameterization instructions.

The embodiment of the sensor 10 described with reference to FIG. 1 is only to be understood as an example. A distance measurement by means of time of flight processes is used in a fairly large family of optoelectronic sensors, for example in scanning or distance measuring light grids, laser scanners, or solid state LiDAR systems of different designs. These sensors 10 can differ substantially in design from FIG. 1; for example, the transmission channel and the reception channel can lead over a common beam splitter or can work passively and can thus fully dispense with a transmission channel. A particularly advantageous embodiment as a multi-beam laser scanner or multilayer laser scanner will finally be presented with reference to FIG. 9.

The heart of the invention relates to the diaphragm 24. It has a layer design that will be explained in more detail in the following, with at least one metallic layer 32 being provided. A potential equalization or a grounding by a conductive connection to a corresponding component of the sensor 10 that lies at the desired potential takes place by means of contact regions of the metallic layer 32. The control and evaluation unit 28 or its expansion card or circuit board is shown in this role in FIG. 1.

FIG. 2 shows a schematic sectional view of a layer system from which the diaphragm 24 is manufactured by way of example. The layer system is still unmachined or a blank in this stage. A transparent substrate, for example a glass substrate 34, and the metallic layer 32 are shown as exemplary layers. In this respect, an absorption layer 36 is provided outwardly on the metallic layer 32 and a further absorption layer 38 is provided between the metallic layer 32 and the glass substrate 34. Instead of the glass substrate 34, a very thin film, for example an aluminum film or a similarly thin carrier material of, for example, 10 μm thickness can be used. The metallic layer 32 can alternatively be arranged on the other side of the glass substrate 34 or further metallic layers are provided on the one side or at both sides.

The use of two absorption layers 36, 38 is to be understood by way of example; the metallic layer 32 can itself already act as an absorption layer; only one absorption layer can be used; or additional absorption layers are present at one side or at both sides of the glass substrate 34. The absorption layers 36, 38 preferably have a high degree of absorption over a wide wavelength range and a minimal hemispherical degree of reflection. The absorber material can be applied over a layer system with a metallic portion. Spray lacquers are also possible. With particularly high quality demands, a structured material on a carbon base can be used, for example structured carbon nanotubes that have a very high degree of absorption and do not shine. Alternatively, structured inorganic coatings can be used that can be technically arranged between the two previously named materials, for instance Acktar Metal Velvet. The absorber material is preferably applied in as thin and as homogeneous a manner as possible so that it can be removed as homogeneously and as free of residue as possible by abrasion or ablation.

Additional layers are conceivable at one side or at both sides of the glass substrate 34 in practically any desired arrangement of the layers. One example is an anti-reflection coating to transmit as much light as possible at the wavelength of the useful light in the region of the later diaphragm apertures, and indeed preferably over a wide angular range of incidence. A further example is a filter layer, preferably having the properties of an optical bandpass filter, by which extraneous light outside the useful wavelength range of the light transmitter 12 is suppressed.

FIG. 3 shows a sectional view in accordance with FIG. 2, now with a diaphragm aperture 40 that was generated by targeted local removal of the material of the absorption layer 36. A laser is preferably used for this, yet more preferably by structuring in an ablation process, in particular using an ultrashort pulse laser, that is a picosecond or femtosecond laser. Diaphragm apertures 40 can thus be generated precisely at any desired positions. The process can be in two steps in that first reference holes are introduced for the optical adjustment and the diaphragm apertures 40 are then ablated after the optical adjustment. The reference holes can already be provided on the delivery of the blank in accordance with FIG. 2 under certain circumstances.

FIG. 4 shows a sectional view of a diaphragm 24 in which the metallic layer 32 for a potential equalization at contact regions 42 is connected to a grounded component 44. The light reception element 26 has a very high optical sensitivity and this is accompanied by a high electrical sensitivity. To reduce electrical interference, grounded shields, not shown, are therefore preferably arranged at least about the light reception element 26. An optical aperture of this shield should remain as small as possible to impair the shielding of electrical interference signals as little as possible. This conventionally causes substantial difficulties because such an aperture still has to transmit the useful light while taking all the component tolerances into account. In accordance with the invention, in contrast, the diaphragm 24 satisfies a dual function as an optical diaphragm and as an electrical shield.

The metallic layer 32 is exposed at the contact regions 42. This can have been correspondingly taken into account in the coating process or corresponding additive or subtractive processes are used such as laser ablation to provide the contact regions 42. The electric connection to the grounded component 44 is established in any desired manner, for example by means of spring contacts, soldering, welding, or other contact possibilities. The diaphragm 24 or its metallic layer 32 is thereby grounded and a particularly efficient protection from electromagnetic interference radiation (EMC, electromagnetic compatibility) is thus provided.

FIG. 5 shows a sectional view of a diaphragm 24 in which a metallic layer for heating is connected to a voltage source 46. Whereas therefore in the embodiment described with respect to FIG. 4 the metallic layer was only grounded, a further function is added here in addition to the EMC shield. Power loss at the metallic layer 32 can namely be generated by applying a voltage that provides a heating of the metallic layer and thus an effective condensation protection. The electrical and thermal resistance can be set by the layer thickness and the material system. Conventional heating elements for avoiding condensation or fogging optical elements, in particular a front screen heating, are thereby no longer required.

FIG. 6 shows a sectional view with a schematic beam course of the received light 20 at the light receiver 26. As also preferably in the other embodiments, the diaphragm 24 is in direct proximity to the light receiver 26 to increase the diaphragm and shield effect. The metallic layer 32 is additionally exposed in a reflection region 48 here. Light portions of the received light 20 that were initially scattered back are thereby again reflected to the light receiver 26, as indicated by the arrows. This contributes to a maximization of the photon yield and acts as a kind of residual light amplifier since initially lost light portions can still be registered by the light reception element 26. This has the additional advantage, in particular in connection with SPADs or SiPMs, that the incident radiation increases the likelihood of a triggering of additional SPAD cells and thus increases the signal quality. When exposing the reflection region 48, laser parameters can be set by which the reflection properties are additionally improved, for example a preferred direction of the reflection is achieved via a hatch pattern.

FIG. 7 again shows a sectional view of a multilayer diaphragm 24 having a metallic layer 32. In FIG. 8, this diaphragm 24 has been machined by a laser at least in a partial region 50 at the surface of the metallic layer 32. It can thereby be achieved, for example, that the partial region 5 is diffusely reflective or is no longer reflective.

FIG. 9 shows a schematic sectional representation through an optoelectronic sensor 10 in an embodiment as a laser scanner. The sensor 10 in this embodiment in a rough distribution comprises a movable scanning unit 52 and a base unit 54. The scanning unit 52 is the optical measurement head, whereas further elements such as a supply, evaluation electronics, terminals, and the like are accommodated in the base unit 54. In operation, the scanning unit 52 is set into a rotational movement about an axis of rotation 58 with the aid of a drive 56 of the base unit 54 to thus periodically scan a monitored zone 18.

A co-rotating optoelectronic scanner similar to that of FIG. 1 is as it were accommodated in the scanning unit 52. This scanner is, however, now designed as multi-beam by way of example. The laser scanner thereby becomes a multilayer scanner. Alternatively, a laser scanner having only one beam or conversely a stationary multi-beam scanner would be conceivable. The light transmitter 12 therefore generates a plurality of light beams as transmitted light 14 by a plurality of light sources 12a, here four light sources 12a purely by way of example. A plurality of remitted light beams accordingly return to the sensor 10 as received light 20. The SPADs 26a of the light receiver 26 each generate, individually or group-wise, a respective received signal for every remitted light beam. A diaphragm 24 having a plurality of diaphragm apertures 40 or a plurality of diaphragms 24 for the different light beams is/are accordingly provided.

The light transmitter 12 and the light receiver 26 are arranged together in the embodiment shown in FIG. 9 on a circuit board 60 that is disposed on the axis of rotation 58 and that is connected to the shaft 62 of the drive 56. This is only to be understood by way of example; practically any desired numbers and arrangements of circuit boards are conceivable. A contactless supply interface and data interface 64 connects the moving scanning unit 52 to the stationary base unit 54. The control and evaluation unit 28 is located there that can at least partially also be accommodated on the circuit board 60 or at another site in the deflection unit 52. In addition to the functions already explained with reference to FIG. 1, the drive 56 is also controlled by it and a signal of an angle measuring unit that is not shown, that is generally known from laser signal travels, and that determines the respective angular position of the scanning unit 52 is evaluated. Two-dimensional polar coordinates of all the object points in a scan plane are available after every scan period from the distances from a scanned object measured by means of time of flight processes and the associated angular position. The respective scan plane is known from the identity of the respective light beam so that a three-dimensional spatial region is scanned overall through a plurality of planes. Strictly speaking, a plane is only scanned for one central light beam with an elevation angle of 0°, otherwise there are cone envelope surfaces that can, however, also be understood in simplified terms as scan planes.

The sensor 10 shown is a laser scanner having a rotating measurement head, namely the scanning unit 52. In this respect, not only an individual transmission/reception module can co-rotate as shown here; further such modules with a vertical offset or an angular offset with respect to the axis of rotation 58 are conceivable. Alternatively, a periodic deflection by means of a rotating mirror or by means of a facet mirror wheel is also conceivable. With a plurality of light beams, it must, however, be noted that how the plurality of transmitted light beams are incident into the monitored zone 18 depends on the respective rotational position since their arrangement rotates by the rotating mirror as known geometrical considerations reveal. A further alternative embodiment pivots the scanning unit 52 to and fro, either instead of the rotational movement or additionally about a second axis perpendicular to the rotational movement to also generate a scanning movement in elevation.

1. An optoelectronic sensor for detecting an object in a monitored zone that comprises a light transmitter for transmitting transmitted light, a light receiver having a plurality of light reception elements operable in Geiger mode to receive transmitted light remitted in the monitored zone, a reception optics arranged upstream of the light receiver and having a diaphragm, and a control and evaluation unit that is configured to determine a distance from the object with reference to a received signal of the light receiver from a time of flight between the transmission of the transmitted light and the reception of the remitted received light, wherein the diaphragm comprises a diaphragm substrate having at least one metallic layer and one diaphragm aperture,
wherein a contact region of the metallic layer for potential equalization is electrically conductively connected to another component of the sensor.

2. The sensor in accordance with claim 1,
that has a conductive shield of at least the light receiver.

3. The sensor in accordance with claim 2, wherein the contact region is electrically conductively connected to the shield.

4. The sensor in accordance with claim 1,
wherein the contact region is electrically conductively connected to an expansion card of the sensor.

5. The sensor in accordance with claim 4,
wherein the expansion card is an expansion card of the control and evaluation unit.

6. The sensor in accordance with claim 1
wherein a voltage can be applied to the metallic layer via the contact region to heat the metallic layer.

7. The sensor in accordance with claim 1
wherein the at least one metallic layer is arranged on a side of the diaphragm substrate facing the light receiver and/or remote from the light receiver.

8. The sensor in accordance with claim 1
wherein a metallic layer facing the light receiver is at least partially exposed to reflect backscattered transmitted light remitted by the light receiver to the light receiver again.

9. The sensor in accordance with claim 8,
wherein the exposed part of the metallic layer is structured to set reflection properties.

10. The sensor in accordance with claim 1
wherein the diaphragm is configured as multilayer having at least one of the following additional layers on a side facing the light receiver and/or remote from the light receiver: an absorption layer, an anti-reflection layer, a filter layer.

11. The sensor in accordance with claim 1
wherein the diaphragm aperture is manufactured by a laser.

12. The sensor in accordance with claim 11
wherein the diaphragm aperture is manufactured by a laser ablation process.

13. The sensor in accordance with claim 12
wherein the diaphragm aperture is manufactured individually using the reception optics.

14. The sensor in accordance with claim 1
that is configured as a laser scanner and has a movable deflection unit with whose aid the transmitted light is periodically guided through the monitored zone, wherein the deflection unit is configured in the form of a rotatable scanning unit in which the light transmitter and/or the light receiver is/are accommodated.

15. The sensor in accordance with claim 1
wherein the light transmitter is configured to transmit a plurality of mutually separate light beams and the light receiver is configured to generate respective received signals from a plurality of remitted light beams.

16. The sensor in accordance with claim 15
wherein the diaphragm has one diaphragm aperture per light beam.
